(19) United States
(12) Patent Application Publication
(10) Pub. No.: US 2026/0287335 A1
(43) Pub. Date: Sep. 24, 2026

(54) GENERATING AND PROJECTING A PSEUDO-RANDOM OPTICAL PATTERN OF DOTS

(71) Applicant: NIL Technology ApS, Kongens Lyngby (DK)

(72) Inventors: Olivier Francois, Copenhagen (DK); Martin Balimann, Zurich (CH); Moritz Schmidlin, Zurich (CH)

(21) Appl. No.: 18/873,821

(22) PCT Filed: Jun. 13, 2023
(86) PCT No.: PCT/EP2023/065805

§ 371 Date: Dec. 11, 2024

Related U.S. Application Data
(60) Provisional application No. 63/352,445, filed on Jun. 15, 2022.

(51) Int. Cl. G01B 11/25; G02B 27/42

(52) U.S. Cl. CPC G01B 11/254; G02B 27/4233

(57) ABSTRACT

Techniques for generating and projecting a pseudo-random optical pattern of dots that can be repeated across an illumination space in the far field are disclosed. In some implementations, the pseudo-random pattern of dots can be achieved using a regular array of light sources.

### FIELD OF THE DISCLOSURE

The present disclosure relates to generating and projecting a pseudo-random optical pattern of dots.

### BACKGROUND

Various consumer products are designed to be able to recognize or navigate around their surroundings. For example, some smartphones provide face recognition using an infra-red (IR) dot projector that serves as a structured light emitter. The projector produces a pattern of infrared dots in front of the smartphone, which can illuminate a face or other object so that it can be photographically captured by the camera. The dot projector can include, for example, an array of light emitting units, lenses, and beam splitters. The lenses and beam splitters generate duplications of the array source pattern, and project a duplicated pattern of dots onto a person's face or other object. An infrared camera can capture the pattern to be used in a structured light algorithm to detect the three-dimensional (3D) shape of the face or other object.

Some applications (e.g., 3D sensing algorithms) can be improved by introducing randomness into the positions of the projected dots. One way to introduce such randomness is to provide an array of emitters that are not aligned on a regular grid. Such an approach, however, can be challenging to implement.

### SUMMARY

The present disclosure describes techniques for generating and projecting a pseudo-random (e.g., irregular) optical pattern of dots that can be repeated across an illumination space in the far field.

As explained in greater detail below, some implementations can achieve the pseudo-randomness using, for example, emitters aligned in a regular array with randomization of spot positions in the illumination space. Some implementations can achieve the pseudo-randomness using, for example, emitters aligned in a regular array combined with randomization of virtual emitter positions.

For example, in accordance with some implementations, an apparatus includes an array of light sources, a first optical fanout structure, and an optical collimator disposed to intersect light emitted by the light sources, wherein output of the collimator is provided to the first optical fanout structure. The first optical fanout structure is operable to split each light incident beam into multiple diffractive orders, wherein only a subset of diffractive orders are activated so as to produce a pseudo-random pattern of dots.

Some implementations include one or more of the following features. For example, in some implementations, the first optical fanout structure is operable to activate (x,y) as a highest diffractive order, wherein at least one diffractive order (m,n) is not activated by the first optical fanout structure, and wherein (i) 0<m<x, or (ii) 0<n<y, or (iii) 0<m<x and 0<n<y. In some instances, the first optical fanout structure is operable such that light beams representing the activated diffractive orders for a particular one of the light sources appear within a same unit-cell illumination, and wherein overlapping tiles produce an irregular pattern of dots in a far-field illumination. In some instances, the first optical fanout structure is operable to produce an intermediate irregular pattern of dots. The apparatus further can include a second optical fanout structure configured to receive the intermediate irregular pattern of dots and to reproduce overlapping tiles of the intermediate irregular pattern of dots, with tessellation, in a far field illumination. In some implementations, the light sources are arranged in a regular array.

In accordance with some implementations, an apparatus includes an array of light sources, a first optical fanout structure, and an optical collimator disposed to intersect light emitted by the light sources, wherein output of the collimator is provided to the first optical fanout structure. The first optical fanout structure includes an array of fanout elements having respective unit cell sizes that differ from one another so as to generate position offsets in one or more higher diffractive orders.

Some implementations include one or more of the following features. For example, the first optical fanout structure can include different adjacent zones whose periods differ from one another. In some cases, the first optical fanout structure includes a piecewise diffractive optical element in which different fanout elements are physically separate from one another. In some instances, the first optical fanout structure includes phase masks of different fanout elements overlaid with one another. The light sources can be arranged, for example, in a regular array.

In accordance with some implementations, an apparatus includes an array of light sources, a substrate having an arrayed diffractive surface operable to introduce an offset for light beams emitted by at least some of the light sources, an optical collimator disposed to intersect light beams that have passed through the substrate, and

an optical fanout structure operable to receive light beams that have passed through the collimator and to split each of such light beams into multiple respective diffractive orders.

Some implementations include one or more of the following features. For example, in some implementations, telecentricity is preserved for light beams passing through the substrate, whereas in some implementations, telecentricity is not preserved for light beams passing through the substrate. The arrayed diffractive surface can include at least one of prisms, gratings, or microlens arrays having a respective lens center shifted with respect to a central optical axis of a corresponding one of the light sources. In some cases, the arrayed diffractive surface of the substrate includes a first array of diffractive optical elements (DOEs), and wherein a second surface of the substrate includes a second array of DOEs operable to correct for tilt introduced by the first array of DOEs. The light sources can be arranged, for example, in a regular array.

Various advantages can be achieved by some implementations. For example, in some implementations, the pseudo-random pattern of dots can be achieved even if the light sources (e.g., VCSELs) are arranged in a regular array.

Other aspects, features and advantages will be readily apparent from the following detailed description, the accompanying drawings and the claims.

### BRIEF DESCRIPTION OF THE DRAWINGS

FIG. 1 illustrates an example of a dot projector.

FIG. 2 illustrates an example of a dot projector for generating a pseudo-random dot pattern.

FIG. 3 illustrates another dot projector for generating a pseudo-random dot pattern.

FIG. 4 illustrates a further dot projector for generating a pseudo-random dot pattern.

FIG. 5 illustrates an example of a pseudo-random dot pattern.

FIG. 6 illustrates another dot projector for generating a pseudo-random dot pattern.

FIG. 7 illustrates yet another dot projector for generating a pseudo-random dot pattern.

### DETAILED DESCRIPTION

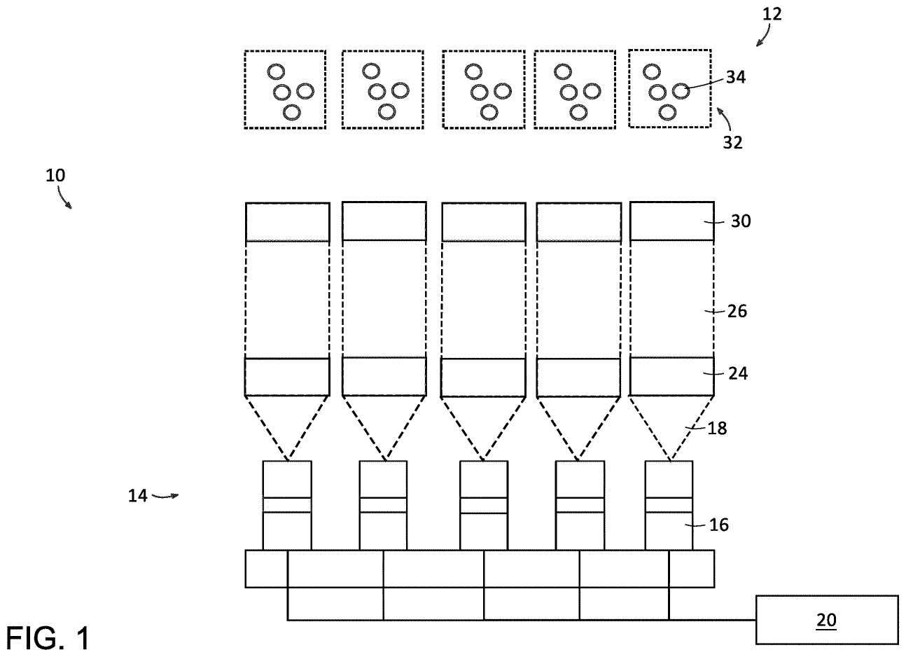

FIG. 1 depicts an example of a dot projection module 10 configured to generate a structured light illumination 12 in the far field. The dot projection module 10 can be operable, for example, as a dot projector. The dot projection module 10 includes a regular array 14 of discrete light sources 16. Each light source 16 within the array 14 is configured to generate a light emission 18. The array 14 of discrete light sources can be configured such that one or more of the light sources 16 are addressable (e.g., via a controller 20 communicatively coupled to each discrete light source in the array). That is, one or more of the light sources 16 can be controlled such that its emission 18 can be regulated (e.g., turned on, off, temporally modulated or altered in some other way such as altering its polarization, wavelength, and so forth). The light sources 16 may be lasers (e.g., vertical-cavity surface emitting lasers (VCSELs)) or other suitable light-emitting devices (e.g., light-emitting diodes).

The dot projection module 10 further includes one or more optical collimators 24 and one or more optical beam splitters (e.g., fanout elements) 30. Each collimator 24 is aligned with one or more of the discrete light sources 16 and is configured to collimate the light emission (collimated emission 26 depicted generated by a corresponding light source 16 to which it is aligned. The collimators 24 may include, for example, diffractive optical elements, refractive optical elements, or meta-optical elements. Each fanout element 30 is aligned with one or more of the collimators 24 and is configured to split light beams into a predetermined number of diffractive orders at respective angles so as to generate, from a corresponding incident collimated emission 26, a unit-cell structured light illumination 32. Each unit-cell structured light illumination 32 corresponds to a portion of the structured light illumination 12 generated in the far field. Each unit-cell structured light illumination 32 includes an array of discrete individual illumination features 34. The fanout elements 30 may be implemented, for example, as diffractive optical elements or meta-optical elements.

The fanout elements 30 can be configured to generate individual illumination features 34 from one or more diffractive orders. In some instances, meta-optical elements may be used to generate a particularly small angular separation between individual illumination features 34. As described below, the illumination features 34 can exhibit a relatively high degree of randomness, that is a pseudo-random or irregular pattern that does not mirror the array of light sources 16.

In the exampled depicted in FIG. 1, each fanout element 30 is configured to split an incident beam into multiple diffractive orders in the x and y dimensions so as to generate multiple individual illumination features in the corresponding unit-cell structured light illumination 32. In the example depicted in FIG. 1, all the discrete light sources 16 are turned on such that their corresponding collimators 24 and fanout elements 30 are illuminated so as to generate a respective unit-cell structured light illumination 32 in a portion of the field of illumination. Collectively, their unit-cell structured light illuminations 32 can span the entire field of illumination.

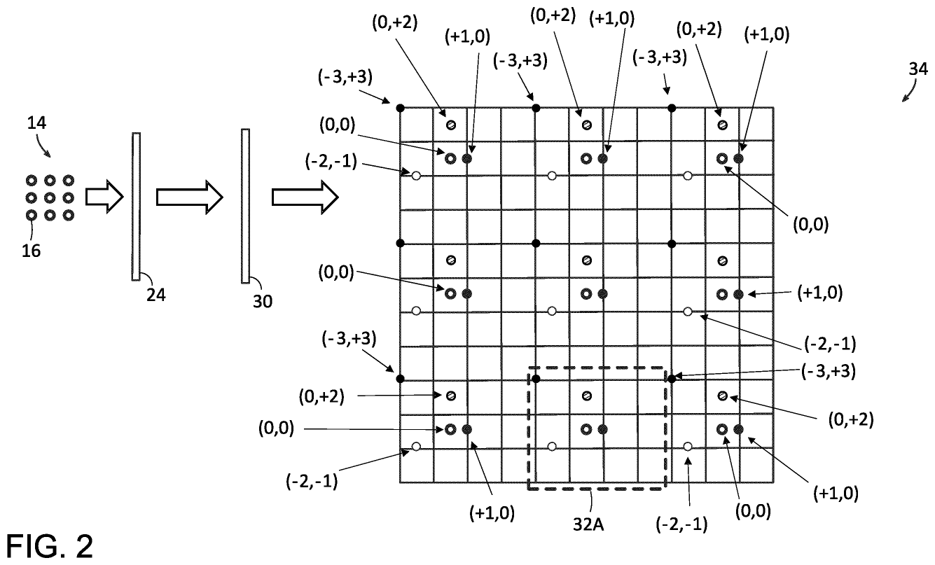

FIG. 2 illustrates a particular implementation in which a fanout element 30 splits the light beam from each particular light source (e.g., VCSEL) 16 into multiple diffractive orders in two dimensions (e.g., the x and y dimensions). The fanout element 30 is configured, however, to activate only a subset of the possible diffractive orders. For example, in the implementation of FIG. 2, the fanout element 30 activates the following diffractive orders: (0,0), (+1,0), (0,+2), (−2,−1), (−3,+3). Other diffractive orders are not activated; that is, they are not present in the output from the fanout element 30 and, therefore do not appear in the field of illumination. In particular, where the highest diffractive order activated by the fanout element 30 is (x,y), at least one diffractive order (m,n) is not activated by the fanout element 30 (where 0≤m<x, or (ii) 0≤n<y, or (iii) 0≤m<x and 0≤n<y). In some instances, multiple lower diffractive orders are not activated by the fanout element 30. The fanout element 30 is further configured so that light beams representing the activated diffractive orders for a given light source (e.g., VCSEL) 16 appear within the same unit-cell illumination 32A. The overlapping tiles (i.e., without tessellation) produce a pseudo-random (e.g., irregular) pattern of dots in the far-field illumination.

Although FIG. 2 illustrates a particular example in which specific diffractive orders of the incident light beams are activated, different subsets of diffractive orders can be activated for other implementations. In some implementations, the fanout element 30 should achieve a relatively small angular separation between tiles (i.e., between the various diffractive orders) so that relatively large unit cells (e.g., 32A) are obtained. In some instances, the collimator 24 has a relatively short focal length, which results in relatively large incidence angles.

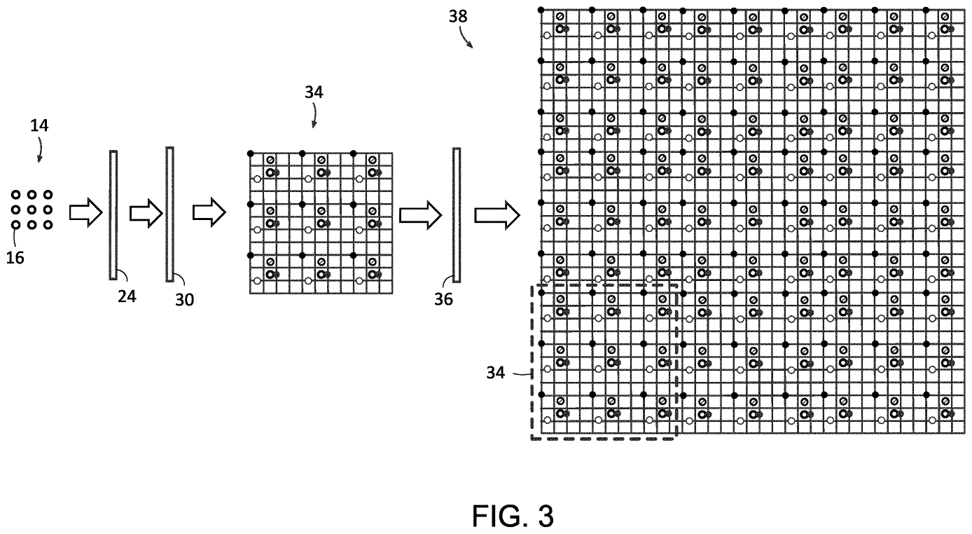

FIG. 3 illustrates another dot projector, in which the desired field of illumination is achieved by providing a second fanout element 36 that receives, as its input, the output 34 from the first fanout element 30 of FIG. 2. In the illustrated implementation, the desired field of illumination can be achieved by providing the second fanout element 36, rather than by reducing the focal length of the collimator 24. The second fanout element 36 generates an

n×m fanout. In the example of FIG. 3, n=m=3. More generally, however, the values of n and m may differ from one another, and either or both may be a positive integer value other than 3. Thus, the overlapping tiles of the intermediate pattern 34 produced by the first fanout element 30 are reproduced, with tessellation, in the far field illumination 38.

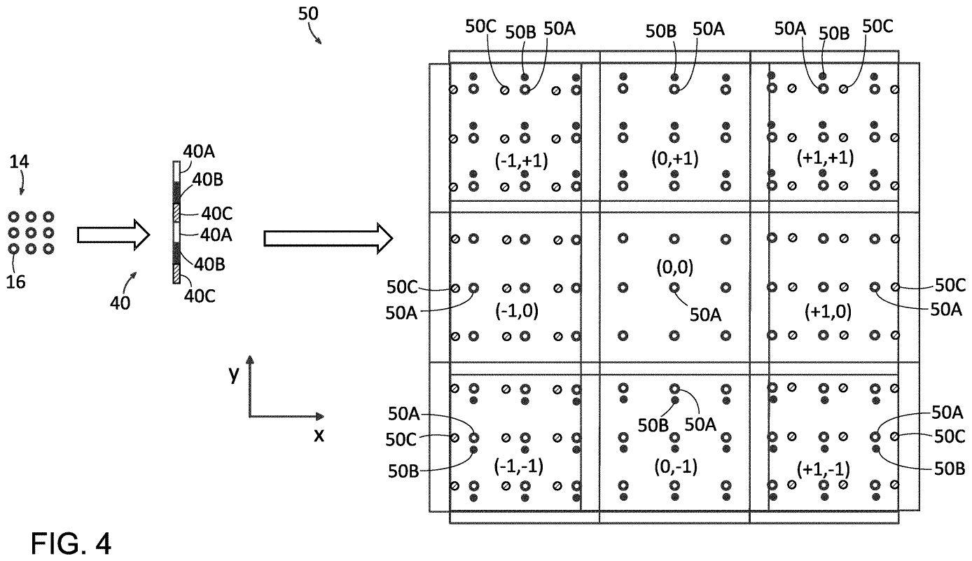

FIG. 4 illustrates another dot projector for generating a pseudo-random dot pattern. In this example, pseudo-randomness is achieved by arraying the fanout. Elements of the fanout array 40 have slightly different unit cell sizes so as to generate small position offsets in the higher diffractive orders. In the illustrated example, the fanout array 40 includes first elements 40A that provide a particular fanout, second fanout elements 40B that provide a small vertical offset (e.g., in the y dimension), and third fanout elements 40C that provide a small lateral offset (e.g., in the x dimension). In some implementations, the magnitude of the lateral offset (81) is the same as the vertical offset (82). Each of the fanout elements 40A, 40B, 40C produces a respective dot pattern in the far field. For example, the first fanout elements 40A produce a first pattern of dots 50A, the second fanout elements 40B produce a second pattern of dots 50B, and third fanout elements 40C produce a third pattern of dots 50C. Each dot 50B of the second pattern is offset vertically by an amount 82 from a respective dot 50A of the first pattern, and each dot 50C of the third pattern is offset horizontally by an amount 81 from a respective dot 50A of the first pattern.

The horizontal and vertical offsets in the dot patterns produced by the arrayed fanout 40 of FIG. 4 can be achieved, for example, by splitting the fanout structure into different adjacent zones and slightly perturbing the period of the second and third fanout elements 40B, 40C. The fanout structure 40 can be implemented, for example, by a piecewise diffractive optical element in which the different fanout elements 40A, 40B, 40C are physically separate from one another. In some instances, the fanout 40 is implemented by overlaying the phase masks of the fanout elements 40A, 40B, 40C with one another.

FIG. 4 also indicates the diffractive modes that produce the dots in each region of the far field illumination. As can be seen from the illustrated example, there are no offset dots produced in the center region for the (0,0) diffractive modes, and only partial offsets are produced in the regions for the (0,x) and (x,0) diffractive modes (i.e., the (0,−1), (0,+1), (−1,0) and (+1,0) modes).

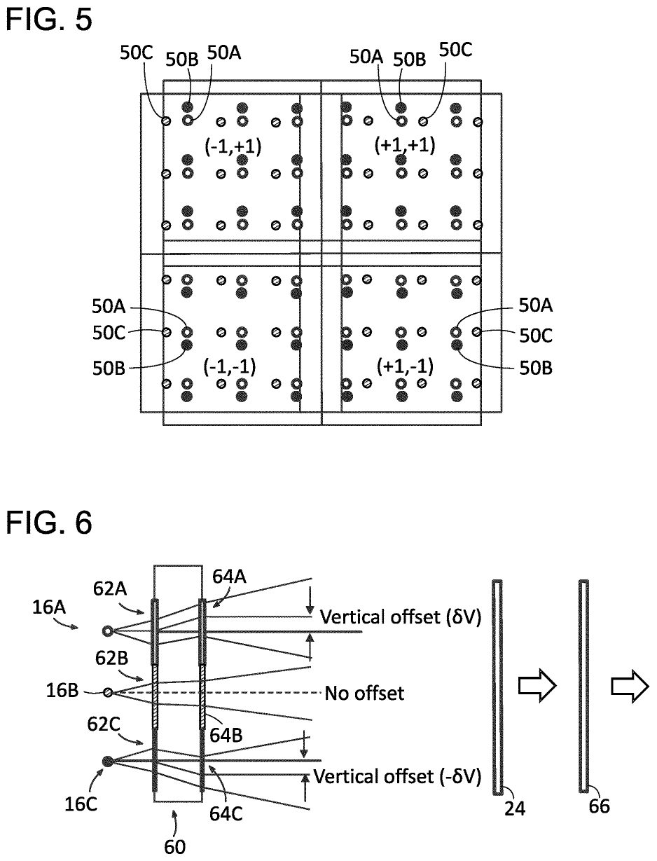

To achieve a degree of pseudo-randomness throughout the far field illumination, the zeroth-order modes can be disabled, and the grating periods tuned so that all regions of the far field illumination display a pseudo-random (e.g., irregular) dot pattern. FIG. 5 illustrates an example of such a dot pattern. In some instances, higher orders may be needed to achieve the target field of illumination without reducing the collimator focal length.

The foregoing implementations can achieve the pseudo-randomness using, for example, emitters aligned in a regular array with randomization of spot positions in the illumination space. On the other hand, as explained below, some implementations can achieve the pseudo-randomness using, for example, emitters aligned in a regular array combined with randomization of virtual emitter positions.

For example, as shown in FIG. 6, an optical system includes an array of light sources (e.g., VCSELs) 16A, 16B, 16C that emit light toward a double-sided optical element 60 composed of a glass or other transparent substrate having a respective array of diffractive optical elements (DOEs) on each of its opposing surfaces. That is, a first side of the optical element 60, on which light from the VCSELs 16A, 16B, 16C is incident, includes a first array of DOEs 62A, 62B, 62C. The second side of the optical element 60, from which the light exits when it passes through the optical element 60, includes a second array of DOEs 64A, 64B, 64C. The pitch of the DOEs 62A, 62B, 62C, as well as the pitch of the DOEs 64A, 64B, 64C, corresponds to the pitch of the VCSELs 16A, 16B, 16C, and each pair of DOEs implements a respective paired linear phase function. For example, a first pair of DOEs 62A, 64A implements a first paired linear phase function, a second pair of DOEs 62B, 64B implements a second paired linear phase function, and a third pair of DOEs 62C, 64C implements a third paired linear phase function.

In the implementation of FIG. 6, the second DOEs (e.g., 64A and 64C) correct for the tilt in the light beams introduced by the corresponding first DOEs (e.g., 62A and 62C). The DOEs are configured such that, after passing through the optical element 60, light beams from some of the VCSELs (e.g., 16A and 16C) are offset relative to the central axis of the incident light. In particular, the light beams can be offset in a direction perpendicular to the central axis of the incident light. Thus, randomization is achieved by offsetting the initial optical axis of at least some of the emitters. The light beams exiting the optical element 60 then can pass through a collimator 24, and subsequently through a fanout element 66 that splits each light beam into multiple diffractive orders.

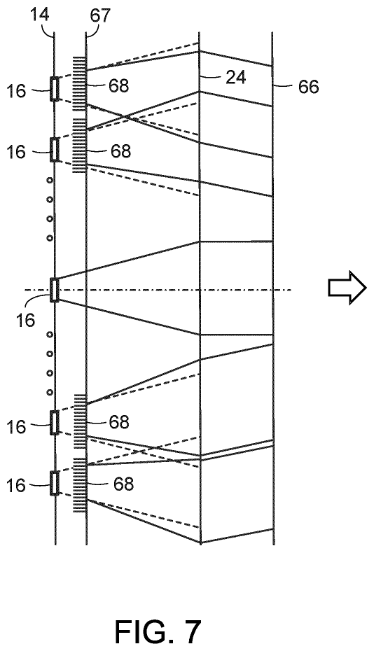

In the implementation of FIG. 6, telecentricity is preserved on the emitter side of the optical system. In other implementations, such as the optical system of FIG. 7, telentricity is not preserved on the emitter side. In this case, the optical system includes an array of light sources (e.g., VCSELs) 16 that emit light toward an optical element 67 composed of a glass or other transparent substrate having an arrayed diffractive surface that introduces a tilt into the optical axis of light beams from at least some of the VCSELs 16. For example, the optical element 67 can have an array of optical randomizers 68 on its surface. Each optical randomizer 68 can be implemented, for example, as a prism, a grating, or a microlens array having a lens center shifted with respect to the central optical axis of the corresponding VCSEL. This implementation does not need to include a second array of DOEs to correct for tilt introduced by the arrayed diffractive surface. The light beams exiting the optical element 67 then can pass through a collimator 24, and subsequently through a fanout element 66 that splits each light beam into multiple diffractive orders.

In some implementations, the collimator and fanout functions may be combined in the same optical element.

The foregoing optical systems can be integrated, for example, into smartphones or other consumer products to provide, e.g., face recognition using an infra-red (IR) dot projector. The projector produces a pattern of infrared dots in front of the smartphone, which can illuminate a face or other object so that it can be photographically captured by the camera. An infrared camera can capture the pattern to be used to detect the three-dimensional (3D) shape of the face or other object.

Other examples of consumer products that may incorporate a dot projector as described above include robotic vacuum cleaners and lawn mowers, machine vision applications (e.g., augmented reality and virtual reality), as well as autonomous guided vehicles (AGVs).

While this document contains many specific implementation details, these should not be construed as limitations on the scope of any inventions or of what may be claimed, but rather as descriptions of features specific to particular embodiments. Certain features that are described in this document in the context of separate embodiments can also can be implemented in combination in a single embodiment. Conversely, various features that are described in the context of a single embodiment can also can be implemented in multiple embodiments separately or in any suitable sub-combination. Various modifications can be made to the foregoing examples. Accordingly, other implementations also are within the scope of the claims.

1. An apparatus comprising:
an array of light sources;
a first optical fanout structure; and
an optical collimator disposed to intersect light emitted by the light sources, wherein output of the collimator is provided to the first optical fanout structure, and
wherein the first optical fanout structure is operable to split each light incident beam into multiple diffractive orders, wherein only a subset of diffractive orders are activated so as to produce a pseudo-random pattern of dots.

2. The apparatus of claim 1 wherein the first optical fanout structure is operable to activate (x,y) as a highest diffractive order, wherein at least one diffractive order (m,n) is not activated by the first optical fanout structure, and wherein (i) 0≤m<x, or (ii) 0≤n<y, or (iii) 0≤m<x and 0≤n<y.

3. The apparatus of claim 1, wherein the first optical fanout structure is operable such that light beams representing the activated diffractive orders for a particular one of the light sources appear within a same unit-cell illumination, and wherein overlapping tiles produce an irregular pattern of dots in a far-field illumination.

4. The apparatus of claim 1, wherein the first optical fanout structure is operable to produce an intermediate irregular pattern of dots, the apparatus further including a second optical fanout structure configured to receive the intermediate irregular pattern of dots and to reproduce overlapping tiles of the intermediate irregular pattern of dots, with tessellation, in a far field illumination.

5. The apparatus of claim 1, wherein the light sources are arranged in a regular array.

6. An apparatus comprising:
an array of light sources;
a first optical fanout structure; and
an optical collimator disposed to intersect light emitted by the light sources, wherein output of the collimator is provided to the first optical fanout structure, and
wherein the first optical fanout structure includes an array of fanout elements having respective unit cell sizes that differ from one another so as to generate position offsets in one or more higher diffractive orders.

7. The apparatus of claim 6 wherein the first optical fanout structure includes different adjacent zones whose periods differ from one another.

8. The apparatus of claim 7 wherein the first optical fanout structure includes a piecewise diffractive optical element in which different fanout elements are physically separate from one another.

9. The apparatus of claim 7 wherein the first optical fanout structure includes phase masks of different fanout elements overlaid with one another.

10. The apparatus of claim 6, wherein the light sources are arranged in a regular array.

11. An apparatus comprising:
an array of light sources;
a substrate having an arrayed diffractive surface operable to introduce an offset for light beams emitted by at least some of the light sources;
an optical collimator disposed to intersect light beams that have passed through the substrate; and
an optical fanout structure operable to receive light beams that have passed through the collimator and to split each of such light beams into multiple respective diffractive orders.

12. The apparatus of claim 11 wherein telecentricity is preserved for light beams passing through the substrate.

13. The apparatus of claim 11 wherein telecentricity is not preserved for light beams passing through the substrate.

14. The apparatus of claim 11 wherein the arrayed diffractive surface includes at least one of prisms, gratings, or microlens arrays having a respective lens center shifted with respect to a central optical axis of a corresponding one of the light sources.

15. The apparatus of claim 11 wherein the arrayed diffractive surface of the substrate includes a first array of diffractive optical elements (DOEs), and wherein a second surface of the substrate includes a second array of DOEs operable to correct for tilt introduced by the first array of DOEs.

16. The apparatus of claim 9, wherein the light sources are arranged in a regular array.
